(19) United States
(12) Patent Application Publication
(10) Pub. No.: US 2024/0309682 A1
(43) Pub. Date: Sep. 19, 2024

(54) Handle Assembly

(71) Applicant: Illinois Tool Works Inc., Glenview, IL (US)

(72) Inventor: Bin CHEN, Shanghai (CN)

(21) Appl. No.: 18/594,865

(22) Filed: Mar. 4, 2024

(30) Foreign Application Priority Data
Mar. 16, 2023 (CN) 2023102695273

(51) Int. Cl. E05B 81/76; E05B 85/10; E05B 85/18

(52) U.S. Cl. CPC E05B 81/77; E05B 85/103; E05B 85/18

(57) ABSTRACT

The present disclosure provides a handle assembly for a door having a handle aperture, the handle assembly comprising a housing, a cover plate and a transmission device. The housing defines an accommodating cavity, a receiving channel and an operating cavity, and has a housing opening, wherein the receiving channel is located at a rear side of the housing opening, the accommodating cavity and the operating cavity are respectively located at the opposite upper side and lower side of the receiving channel and interconnected to each other through the receiving channel. The accommodating cavity of the housing is configured to accommodate the cover plate when the cover plate is in an open position, and the operating cavity of the housing is configured to at least partially accommodate an operator's hand for opening the door. In the handle assembly of the present disclosure, when the cover plate is in the open position, the cover plate and the operating element are respectively located in the accommodating cavity and the operating cavity, so that the cover plate will not hinder the operator's hand from operating the operating element, so as to prevent the operator's hand from hitting the cover plate.

### RELATED APPLICATION

The present application claims the benefit of Chinese Patent Application No. 2023102695273, filed Mar. 16, 2023, titled “Handle Assembly,” the contents of which are hereby incorporated by reference.

### TECHNICAL FIELD

The present disclosure relates to the field of vehicle parts, and in particular to a handle assembly for opening a door of a vehicle.

### BACKGROUND

In a vehicle, a handle assembly is provided on a sheet metal part of a door, and the door of the vehicle can be opened by means of the handle assembly. For some existing hidden door handle assemblies, the handle assembly is configured to be substantially flush with the sheet metal part of the door when it is not in use, so that the handle assembly can be visually hidden in the sheet metal part of the door, thus achieving a more artistic appearance. When it is necessary to use the handle assembly, the handle assembly is moved to an open position to expose a cavity for an operator to operate, so as to facilitate the operator to open the door.

### SUMMARY OF THE DISCLOSURE

The present disclosure relates generally to a handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a structural perspective diagram of a handle system according to an embodiment of the present disclosure from one perspective.

FIG. 1B is a structural perspective diagram of a handle assembly in FIG. 1A from another perspective.

FIG. 1C is an exploded view of the handle assembly in FIG. 1A from one perspective.

FIG. 1D is an exploded view of the handle assembly in FIG. 1A from another perspective.

FIG. 2A is a structural perspective diagram of a transmission device and a cover plate in FIG. 1A from one perspective.

FIG. 2B is a side view of FIG. 2A.

FIG. 3A is a front view of the handle assembly when the cover plate is in a closed position.

FIG. 3B is a cross-sectional view of the handle assembly shown in FIG. 3A along line A-A.

FIG. 4A is a front view of the handle assembly when the cover plate is in a retracted position.

FIG. 4B is a cross-sectional view of the handle assembly shown in FIG. 4A along line B-B.

FIG. 5A is a front view of the handle assembly when the cover plate is in an open position.

FIG. 5B is a cross-sectional view of the handle assembly shown in FIG. 5A along line C-C.

FIG. 6A is a structural perspective diagram of the handle assembly assembled to the door when the cover plate is in the closed position.

FIG. 6B is a structural perspective diagram of the handle assembly assembled to the door assembly when the cover plate is in the open position.

FIG. 7 is a structural schematic diagram of a controller.

FIG. 8A shows a flow chart of a process of an operator getting on a vehicle.

FIG. 8B shows a flow chart of a process of the operator getting off the vehicle.

FIG. 9A is a structural perspective diagram of a handle assembly according to another embodiment of the present disclosure.

FIG. 9B is a structural perspective diagram of the handle assembly shown in FIG. 9A from another perspective.

FIG. 9C is an exploded view of the handle assembly shown in FIG. 9A.

### DETAILED DESCRIPTION OF EMBODIMENTS

Various specific implementations of the present disclosure will be described below with reference to the accompanying drawings which form a part of this description. It should be understood that although the terms for indicating orientations, such as “front”, “rear”, “upper”, “lower”, “left”, “right”, “top”, “bottom”, “inner” and “outer”, are used in the present disclosure to describe structural parts and elements in various examples of the present disclosure, these terms are used herein only for ease of illustration and are determined based on the exemplary orientations shown in the drawings. Since the arrangements in the embodiments disclosed in the present disclosure may be in different directions, these terms indicating directions are merely illustrative and should not be considered as limitations.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

In a first aspect, the present disclosure provides a handle assembly for a door having a handle aperture. The handle assembly comprises: a housing, a cover plate and a transmission device. The housing defines an accommodating cavity, a receiving channel and an operating cavity and has a housing opening, wherein the receiving channel is located at a rear side of the housing opening, the accommodating cavity and the operating cavity are respectively located at the opposite upper side and lower side with respect to the receiving channel and interconnected to each other through the receiving channel, and the housing opening is configured to be aligned with the handle aperture of the door. The cover plate has a closed position and an open position, and the cover plate is configured to close the handle aperture of the door in the closed position and to open the handle aperture of the door in the open position. The transmission device is disposed in the housing and connected to the cover plate, and the transmission device is capable of moving the cover plate between the closed position and the open position in response to an electronic signal. The accommodating cavity of the housing is configured to accommodate the cover plate when the cover plate is in the open position, and the operating cavity of the housing is configured to at least partially accommodate an operator's hand for opening the door.

According to the first aspect described above, the cover plate also has a retracted position, and the cover plate is arranged such that the cover plate is located in the receiving channel when the cover plate is in the retracted position. The transmission device is configured to move the cover plate back and forth between the closed position and the retracted position, and to move the cover plate up and down between the retracted position and the open position.

According to the first aspect described above, a back-and-forth movement of the cover plate between the closed position and the retracted position and an up-and-down movement between the retracted position and the open position are translational movements.

According to the first aspect described above, the transmission device comprises a gear, a rack and at least one connecting rod, the gear and the rack are meshed with each other, the at least one connecting rod is hinged to the rack and the cover plate respectively to connect the rack and the cover plate, and the rack extends in an up-down direction. The handle assembly further comprises a limiting structure disposed on the cover plate and a fitting structure for the limiting structure disposed on the housing, and the limiting structure is engaged with the fitting structure for the limiting structure. The transmission device, the limiting structure and the fitting structure for the limiting structure enable the cover plate to move back and forth between the closed position and the retracted position, and to move up and down between the retracted position and the open position.

According to the first aspect described above, the transmission device comprises two connecting rods parallel to each other.

According to the first aspect described above, the gear is disposed at a side of the rack along a left-right direction of the rack.

According to the first aspect described above, the gear is disposed at a side of the rack along a front-rear direction of the rack.

According to the first aspect described above, the limiting structure comprises a limiting pin disposed on at least one end of the cover plate in a left-right direction of the cover plate, the fitting structure for the limiting structure comprises a groove with trajectory formed on an inner wall of the housing, and the limiting pin is capable of sliding in the groove with trajectory.

According to the first aspect described above, the groove with trajectory comprises a first groove segment and a second groove segment interconnected to each other, the second groove segment extends parallel to the rack, and the first groove segment is located below the second groove segment and extends obliquely relative to the second groove segment. The cover plate is configured to move between the closed position and the retracted position when the limiting pin is sliding within the first groove segment, and move between the retracted position and the open position when the limiting pin is sliding within the second groove segment.

According to the first aspect described above, the handle assembly further comprises an operating element, and the operating element comprises a sensing device configured to detect the operator's hand and to send a signal.

According to the first aspect described above, the sensing device is disposed on a side wall of the housing close to the handle aperture to allow the operator's hand to access the operating cavity from the housing opening through the receiving channel so as to be detected by the sensing device.

According to the first aspect described above, the sensing device comprises a capacitive sensor.

According to the first aspect described above, the sensing device comprises an ultrasonic sensor.

According to the first aspect described above, a pair of side walls of the housing defining the operating cavity extend obliquely relative to each other from top to bottom, so that the bottom dimension of the operating cavity is smaller than the top dimension thereof.

According to the first aspect described above, the handle assembly further comprises a seal ring. The seal ring surrounds the housing opening and the cover plate is used for connecting between the housing and the door.

According to the first aspect described above, the handle assembly further comprises a motor. The motor is connected to the transmission device and configured to provide a driving force to the transmission device in response to the electronic signal.

According to the first aspect described above, the handle assembly is configured such that the cover plate is substantially flush with an outer surface of the door when the cover plate is in the closed position.

In a second aspect, the present disclosure provides a handle system for a door having a handle aperture comprising: a handle assembly and a controller. The handle assembly comprises a housing, a cover plate and an operating element. The housing defines an accommodating cavity, a receiving channel and an operating cavity, wherein the receiving channel is located at a rear side of the handle aperture of the door, the accommodating cavity and the operating cavity are respectively located at the opposite upper side and lower side with respect to the receiving channel and interconnected to each other through the receiving channel. The cover plate has a closed position and an open position, wherein the accommodating cavity of the housing is configured to accommodate the cover plate when the cover plate is located in the open position, and the operating cavity of the housing is configured to at least partially accommodate an operator's hand for opening the door. The operating element comprises a sensing device configured to detect the operator's hand and to send a control signal. The controller receives the control signal from the sensing device to control the cover plate to move from the closed position to the open position, or to control the cover plate to move from the open position to the closed position.

According to the second aspect mentioned above, the controller controls the door to be locked or unlocked according to the control signal.

According to the second aspect mentioned above, the control signal comprises an external control signal and an internal control signal. The sensing device comprises a capacitive sensor, wherein the capacitive sensor is configured to: send the external control signal in response to a contact by the operator's hand outside the handle assembly; and send the internal control signal in response to a contact by the operator's hand inside the operating cavity of the handle assembly.

According to the second aspect mentioned above, the control signal comprises an external control signal and an internal control signal. The sensing device comprises an ultrasonic sensor, wherein the ultrasonic sensor is configured to: send the external control signal in response to the operator's hand within a predetermined distance outside the handle assembly; and send the internal control signal in response to the operator's hand inside the operating cavity of the handle assembly.

According to the second aspect mentioned above, when the cover plate is in the closed position and when the controller receives the external control signal, the controller controls the cover plate to move to the open position. When the cover plate is in the open position and when the controller receives the external control signal or the controller receives no signal for a predetermined time, the controller controls the cover plate to move to the closed position.

According to the second aspect mentioned above, when the controller receives the internal control signal, the controller controls the door to be unlocked for an operator to open the door. When the door is in a closed and unlocked state and when the controller receives the external control signal or receives no signal for a predetermined time, the controller controls the door to be locked.

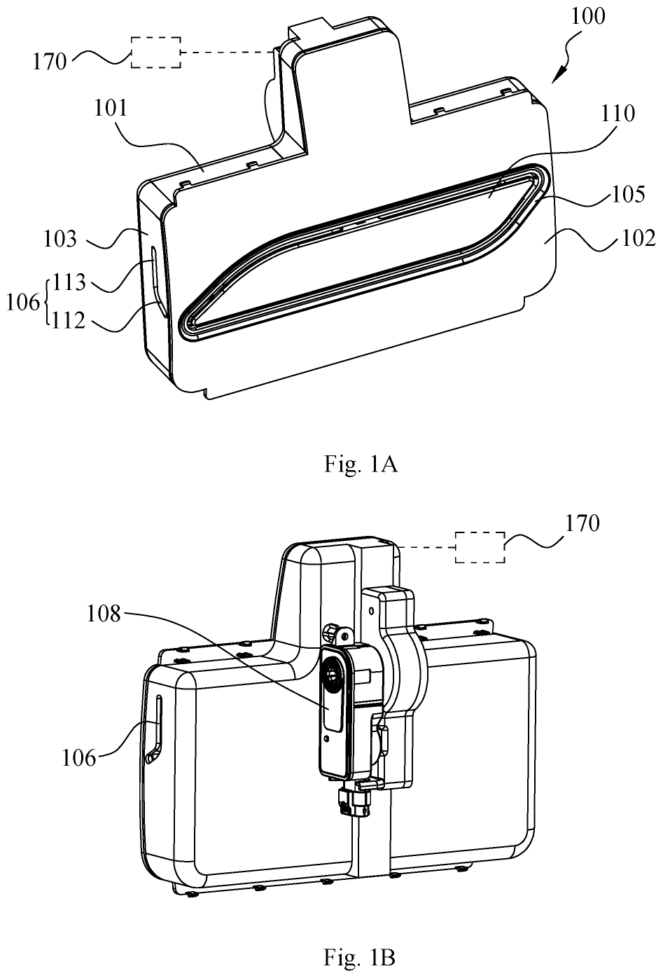

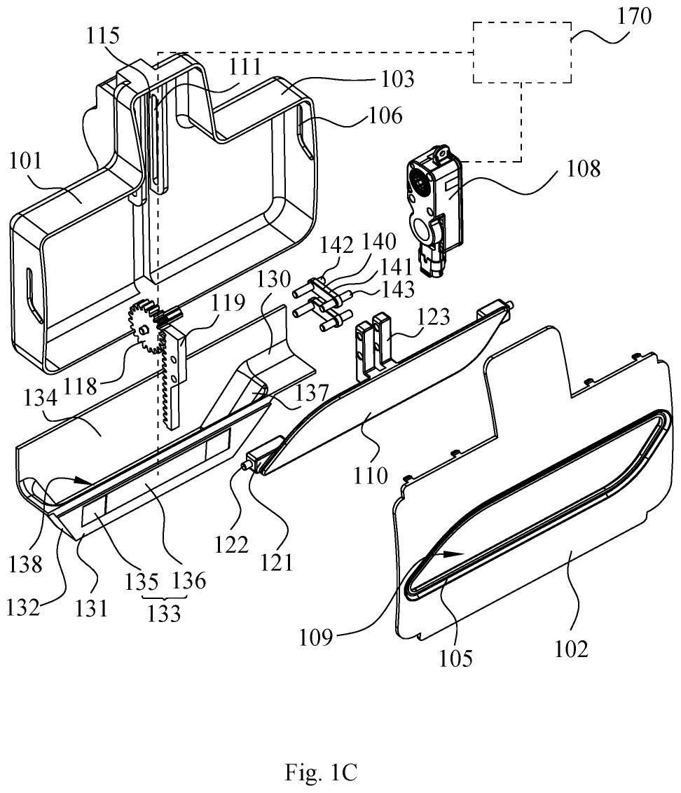

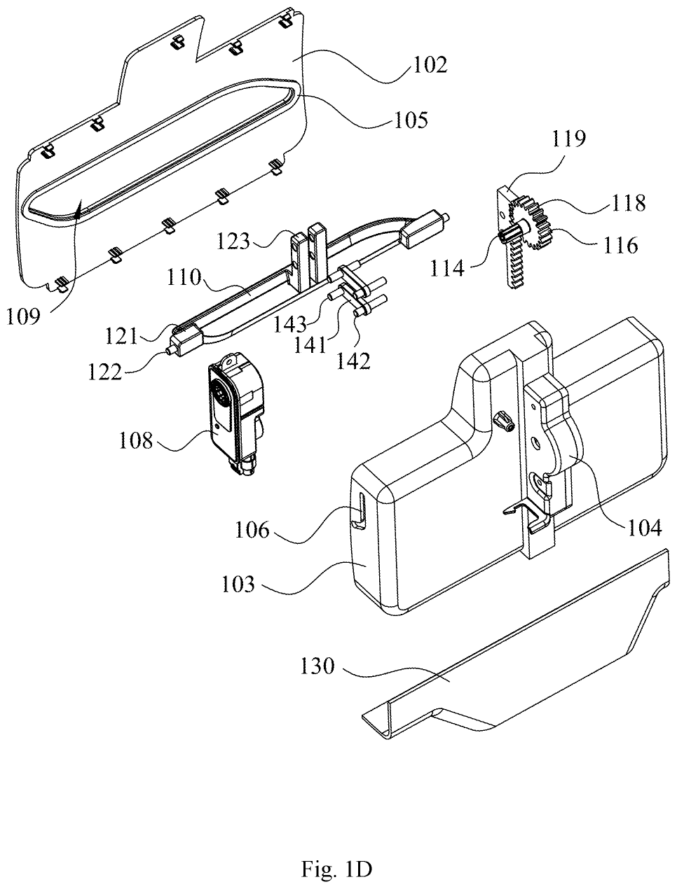

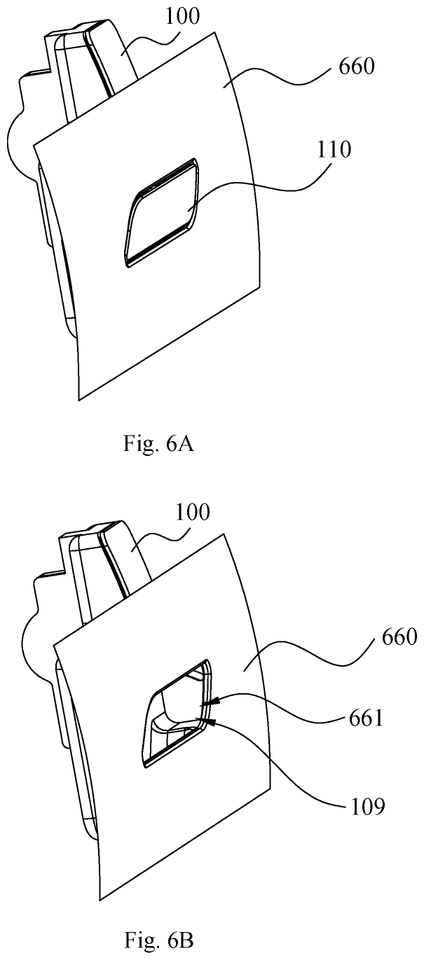

FIGS. 1A to 1D show a general structure of a handle system according to an embodiment of the present disclosure. The handle system comprises a handle assembly 100 and a controller 170, and the handle assembly 100 is communicatively connected to the controller 170. The handle assembly 100 is configured to be mounted to a door of a vehicle, and is specifically mounted at an inner side of the door 660 having a handle aperture 661 (see FIGS. 6A and 6B). FIG. 1A shows a structural perspective diagram of the handle assembly 100 in the handle system from a front-to-rear perspective, FIG. 1B shows a structural perspective diagram of the handle assembly 100 from a rear-to-front perspective, and FIGS. 1A and 1B illustrate an external structure of the handle assembly 100. FIG. 1C shows an exploded view of the handle assembly 100 from a front-to-rear perspective, FIG. 1D shows an exploded view of the handle assembly 100 from a rear-to-front perspective, and FIGS. 1C and 1D show an internal structure of the handle assembly 100, with the controller 170 being omitted in FIG. 1D. As shown in FIGS. 1A to 1D, the handle assembly 100 comprises a substantially square box-shaped housing 101 and a cover plate 110. A front side of the housing 101 has a housing opening 109 aligned with the handle aperture 661 of the door 660 (see FIGS. 6A and 6B). The cover plate 110 has an open position and a closed position, and the cover plate 110 can open the housing opening 109 and the handle aperture 661 in the open position and close the housing opening 109 and the handle aperture 661 in the closed position. A motor 108 is connected to a rear side of the housing 101, and the motor 108 is communicatively connected to the controller 170. The motor 108 drives the cover plate 110 to move between the open position and the closed position by means of a transmission device disposed inside the housing 101. In the embodiment of the present disclosure, the cover plate 110 also has a retracted position. The cover plate 110 needs to pass by the retracted position when moving between the open position and the closed position.

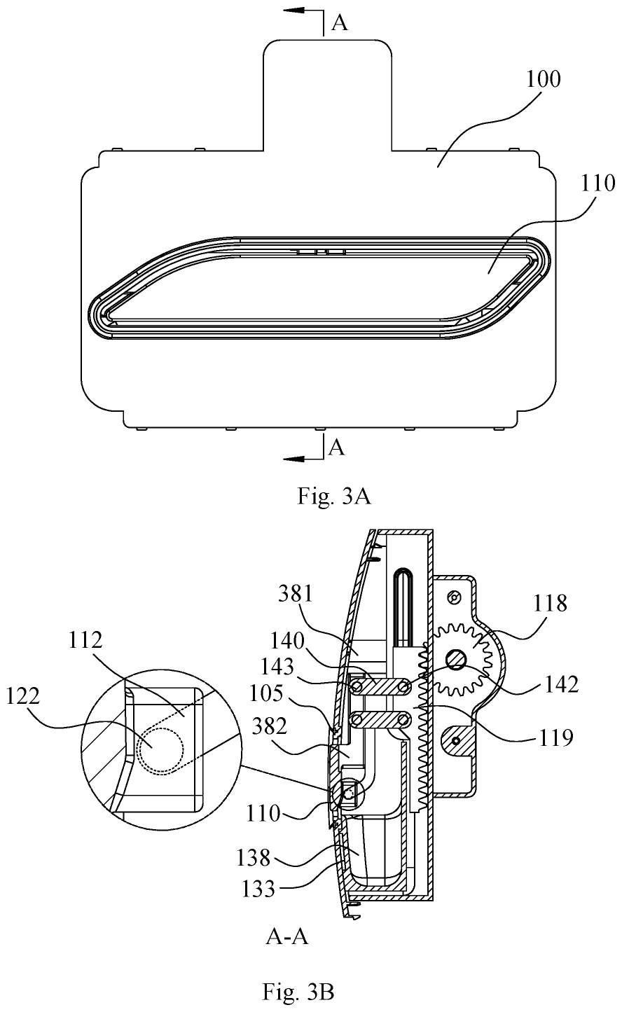

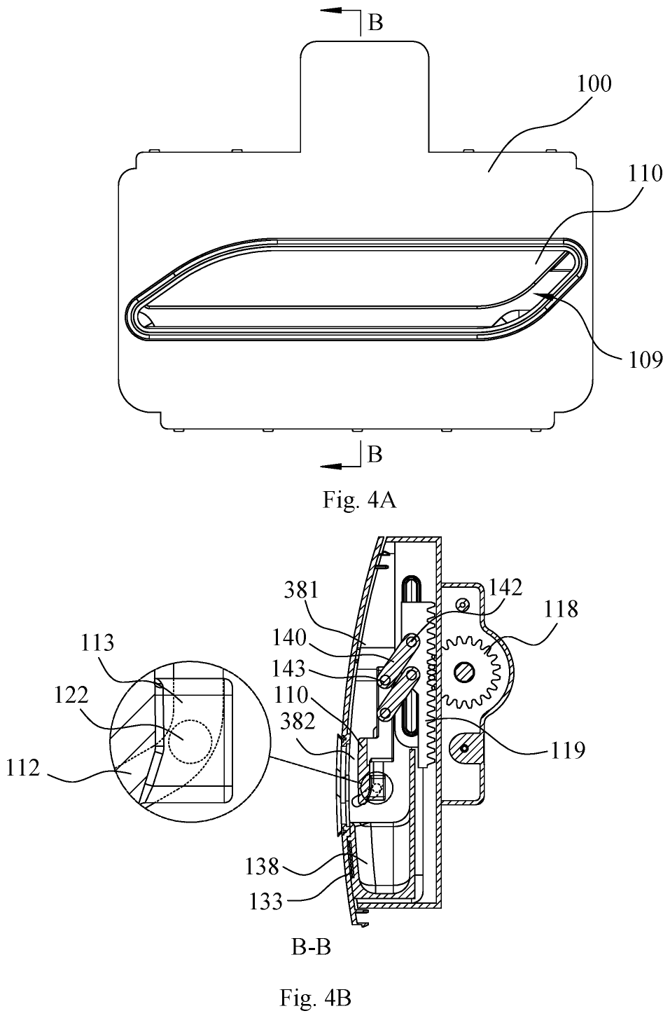

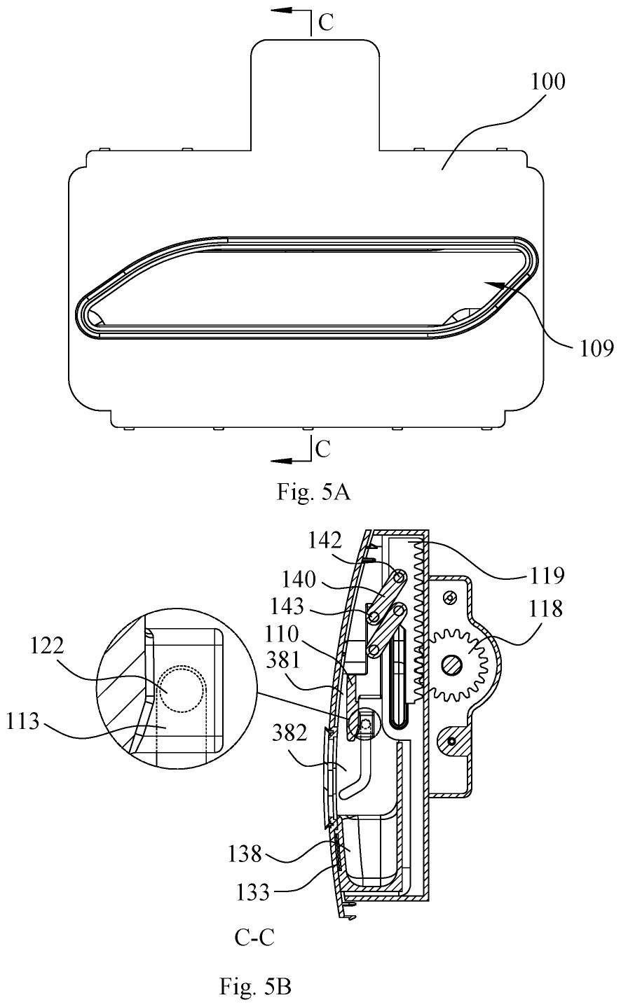

Further, as shown in FIGS. 1C and 1D, the housing 101 defines internal cavities including an accommodating cavity 381, a receiving channel 382 (see FIG. 3B) and an operating cavity 138, the receiving channel 382 is located at the rear side of the housing opening 109, and the accommodating cavity 381 and the operating cavity 138 are respectively located at the opposite upper side and lower side with respect to the receiving channel 382 and interconnected to each other through the receiving channel 382. In this embodiment, the accommodating cavity 381 is located at the upper side with respect to the receiving channel 382, and the operating cavity 138 is located at the lower side with respect to the receiving channel 382. In some other embodiments, the accommodating cavity may also be located at the lower side with respect to the receiving channel, and the operating cavity is located at the upper side with respect to the receiving channel. When the cover plate 110 is in the closed position, the cover plate 110 is located in the housing opening 109 (see FIG. 3B). When the cover plate 110 is in the retracted position, the cover plate 110 is located in the receiving channel 382 (see FIG. 4B). When the cover plate 110 is in the open position, the cover plate 110 is located in the accommodating cavity 381 (see FIG. 5B), and the operating cavity 138 is exposed through the housing opening 109. Then, an operator's hand can access the operating cavity 138 through the handle aperture 661 and the housing opening 109. The operating cavity 138 may at least partially accommodate the operator's hand (e.g., fingers). Therefore, after the cover plate 110 is opened, the cover plate 110 will not hinder the operator's hand from operating in the operating cavity 138, so as to prevent the cover plate 110 from intervening the operator's hand.

The transmission device is configured to move the cover plate 110 back and forth between the closed position and the retracted position, and to move the cover plate 110 up and down between the retracted position and the open position. Specifically, when the cover plate 110 moves from the closed position to the open position, the cover plate 110 substantially moves backward to move from the closed position to the retracted position, and then moves upward to move from the retracted position to the open position. When the cover plate 110 moves from the open position to the closed position, the cover plate 110 substantially moves downward to move from the open position to the retracted position, and then moves forward to move from the retracted position to the closed position. In some embodiments, the transmission device is configured such that an up-and-down movement and a back-and-forth movement of the cover plate 110 are translational movements. Compared with a turning movement of the cover plate 110, this can save more space of the handle assembly 100 in a front-rear direction, so that the handle assembly 100 is thinner.

In the embodiment as shown in FIGS. 1A to 1D, the housing 101 comprises a box 103 and a front end plate 102 that is detachably connected to a front end of the box 103, for example, by means of a snap-fit structure. The interior of the box 103 is configured to accommodate the transmission device and define the accommodating cavity 381, the receiving channel 382 and the operating cavity 138. The front portion of the box 103 is open, and the front end plate 102 closes the box 103 from a front side. The housing opening 109 is disposed on the front end plate 102. Such an arrangement can facilitate the assembly of the handle assembly 100.

The handle assembly 100 further comprises an operating element to be operated by the operator's hand. The operating element comprises a sensing device 133, and the sensing device 133 is communicatively connected to the controller 170. The sensing device 133 is configured to detect the operator's hand and to send a corresponding signal to the controller 170. In this embodiment, the sensing device 133 is disposed on a side wall of the housing 101 close to the handle aperture 661 to allow the operator's hand to be detected by the sensing device 133 when the hand accesses the operating cavity 138. In this embodiment, the sensing device 133 comprises an ultrasonic sensor 135 and an ultrasonic sensor 136 that are stacked. The ultrasonic sensor 136 is disposed at an outer side of the ultrasonic sensor 135. For example, the ultrasonic sensor 136 is configured to send an external control signal to the controller 170 in response to the operator's hand within a predetermined distance outside the handle assembly 100. In addition, the ultrasonic sensor 135 is configured to send an internal control signal to the controller 170 in response to the operator's hand within the operating cavity 138. In some embodiments, the ultrasonic sensor may also be sized such that the ultrasonic sensor has detection regions of different sizes. For example, the length of the ultrasonic sensor 136 is less than the length of the ultrasonic sensor 135, and the ultrasonic sensor 136 is located in the middle of the ultrasonic sensor 135, such that the operator's hand inside the operating cavity 138 corresponds to a larger detection region than the operator's hand outside the door. For the operator, after the operator's hand accesses the operating cavity 138, his line of sight will be obstructed, and the larger detection region can facilitate the operator to perform blind operations. Since the ultrasonic sensor can penetrate metal and plastic materials and can detect the operator's hand based on an ultrasonic signal, the operator does not need to directly touch the ultrasonic sensor. In this way, even if the ultrasonic sensor is disposed on the handle assembly 100 inside the door 660, the operator's hand outside the door 660 or inside the operating cavity 138 can still be detected, so that there is no need to provide an additional sensor on the door 660, making the door 660 have a flatter and more artistic appearance. In some other embodiments, the sensing device 133 may further comprise capacitive sensors that detect the operator's hand by means of the operator's touch operations. The capacitive sensors may be respectively disposed outside the door and inside the operating cavity for the operator to perform a contact operation. In some embodiments, the capacitive sensor outside the door is configured to send an external control signal to the controller 170 in response to the operator's hand within a predetermined distance outside the handle assembly 100. In addition, the capacitive sensor inside the operating cavity is configured to send an internal control signal to the controller 170 in response to the operator's hand inside the operating cavity 138.

In this embodiment, the housing 101 further comprises a box 130 having an open upper portion. The box 130 is disposed at a lower portion of the housing 101, and the operating cavity 138 is formed inside the box 130. The box 130 comprises a front side wall 131 and a rear side wall 134 opposite to each other in a front-rear direction, and a left side wall 132 and a right side wall 137 opposite to each other in a left-right direction. The front side wall 131 and the rear side wall 134 substantially extend in parallel, and the left side wall 132 extends obliquely relative to the right side wall 137 from top to bottom, such that the bottom dimension of the operating cavity 138 is smaller than the top dimension thereof. In this embodiment, the sensing device 133 is disposed on the front side wall 131, for example, on an outer surface of the front side wall 131. The operating cavity 138 having a bottom dimension smaller than its top dimension can be more convenient for the operator to perform blind operations. In some other embodiments, the separately disposed box 130 may not be provided. In this case, the sensing device 133 may be directly disposed at an inner side of the front end plate 102.

The transmission device of the handle assembly 100 is in transmission connection with the motor 108 and the cover plate 110, so that the cover plate 110 can be driven by the motor 108 to move between the open position, the retracted position and the closed position. The transmission device is disposed in the upper portion of the housing 101, so that when the cover plate 110 is in the open position, the transmission device can be at least partially covered by the housing 101, thereby improving the aesthetic appearance of the door.

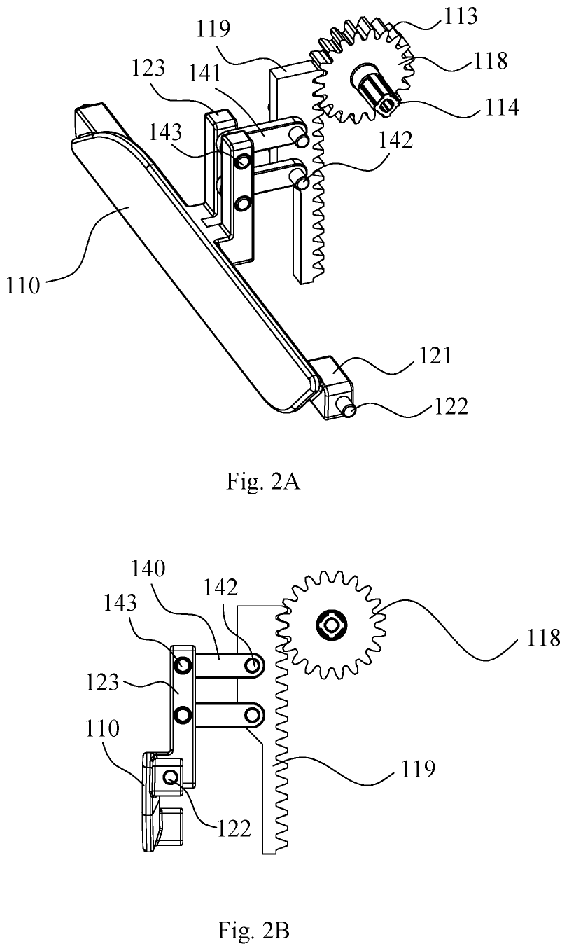

Specifically, the transmission device comprises a gear 118 and a rack 119 that are meshed with each other, and at least one connecting rod 140. The gear 118 is disposed inside the housing 101 and accommodated in a protrusion 104 at the rear side of the housing 101. The motor 108 is engaged with the gear 118 to drive the gear 118 to rotate. The rack 119 is disposed at a front side of the gear 118, and the rotation of the gear 118 drives the rack 119 to move in an up-down direction. The connecting rod 140 is hinged to the rack 119 and the cover plate 110, so that the movement of the rack 119 can drive the cover plate 110 to move and allow the cover plate 110 to have a freedom of movement. Each connecting rod 140 comprises a rod portion 141, one end of the rod portion 141 is hinged to the rack 119 by means of a shaft 142, and the other end of the rod portion 141 is hinged to the middle of the cover plate 110 by means of a shaft 143. The specific structure of the transmission device will be described in detail with reference to FIGS. 2A and 2B.

The handle assembly 100 further comprises a limiting structure disposed on the cover plate 110 and a fitting structure for the limiting structure disposed on the housing 101, and the limiting structure is engaged with the fitting structure for the limiting structure. The arrangement of the limiting structure and the fitting structure for the limiting structure engaged with each other can control a movement track of the cover plate 110 during the movement. In this way, the motor 108 can drive the gear 118 to rotate to move the cover plate 110 between the open position, the retracted position and the closed position according to a predetermined movement trajectory.

In this embodiment, the limiting structure comprises a limiting pin 122 disposed on at least one end of the cover plate 110 in the left-right direction. The fitting structure for the limiting structure comprises a groove with trajectory 106 disposed at a corresponding position on an inner wall of the housing 101. The limiting pin 122 can slide in the corresponding groove with trajectory 106. Specifically, a left end and a right end of the cover plate 110 are each connected to a support block 121, and an outwardly protruding limiting pin 122 is disposed on an end surface of an outer side of each support block 121. The groove with trajectories 106 are formed at corresponding positions on a left side wall and a right side wall of the box 103 of the housing 101. Each groove with trajectory 106 comprises a first groove segment 112 and a second groove segment 113 interconnected to each other. The first groove segment 112 is located below the second groove segment 113. The second groove segment 113 is substantially parallel to an extension direction of the rack 119, that is, extends in the up-down direction. The first groove segment 112 extends obliquely relative to the second groove segment 113. The first groove segment 112 extends obliquely downward from the bottom of the second groove segment 113 in a rear-to-front direction. When the cover plate 110 is in the closed position, the limiting pin 122 is located at the most front end of the first groove segment 112. When the cover plate 110 is in the retracted position, the limiting pin 122 is located at a connection between the first groove segment 112 and the second groove segment 113. When the cover plate 110 is in the open position, the limiting pin 122 is located at the top end of the second groove segment 113. In this way, the movement trajectory of the cover plate 110 can be controlled by means of controlling the shape of the groove with trajectory 106. In this embodiment, the connecting rod 140 is hinged to the middle of the cover plate 110, and the limiting structure is disposed at the two ends of the cover plate 110, so that the cover plate 110 can move more smoothly.

A pair of parallel rails 115 are further provided inside the housing 101. The rails 115 extend in the up-down direction, and a elongate hole 111 extending in the up-down direction is formed in each rail 115. The rails 115 are configured to limit the movement direction of the rack 119.

The handle assembly 100 further comprises a seal ring 105. The seal ring 105 surrounds the housing opening 109 and the cover plate 110 for connecting between the housing 101 and the door 660, so as to prevent dust and water droplets from entering a gap between the handle assembly 100 and the door 660 through the handle aperture 661. As an example, the seal ring 105 is connected to the front side of an edge of the housing opening 109 by means of an injection molding process, and a front side edge of the seal ring 105 protrudes from the front end plate 102 of the housing 101 to abut against the inner side of the door 660.

FIGS. 2A and 2B show a fit structure of the transmission device. FIG. 2A shows a structural perspective diagram of the gear 118, the rack 119 and the cover plate 110, and FIG. 2B shows a side view of the gear 118, the rack 119 and the cover plate 110. As shown in FIGS. 2A and 2B, the gear 118 comprises a toothed portion 116 and a power receiving portion 114 that protrudes outward in an axial direction of the gear 118. The power receiving portion 114 extends out of the housing 101 and is engaged with the motor 108, and is then driven by the motor 108 to rotate so as to drive the toothed portion 116 to rotate.

The rack 119 is substantially in the shape of a strip extending vertically in the up-down direction, and the rear side of the rack 119 is provided with teeth that are meshed with the toothed portion 116 of the gear 118, so that the rotation of the gear 118 drives the rack 119 to move up and down. The front side of the rack 119 is configured to be hinged to the connecting rod 140. Specifically, the shaft 142 of each connecting rod 140 penetrates the rack 119 and the corresponding rod portion 141, and two ends of the shaft 142 are configured to be inserted into the corresponding elongate holes 111 of the rails 115. In this way, the shaft 142 can only rotate or move up and down in the extension direction of the elongate holes 111, so as to limit the rack 119 to only move up and down. In this embodiment, the movement of the rack 119 is limited by means of limiting the movement of the shaft 142. Those skilled in the art should understand that in other embodiments, other limiting structures can also be used to limit the rack 119 to only move up and down, for example, the limiting structure is directly disposed on the rack 119 instead of limiting the movement of the shaft 142.

Two connecting blocks 123 arranged side-by-side are provided at the rear side of the middle of the cover plate 110. The middle of the shaft 143 of each connecting rod 140 penetrates the rod portion 141, and the two ends of the shaft 143 are respectively hinged to one connecting block 123. In this way, each connecting rod 140 is hinged to the connecting block 123 by means of the shaft 143 such that the up-and-down movement of the rack 119 can drive the cover plate 110 to move by means of the connecting rod 140, and the shaft 142 and the shaft 143 of the connecting rod 140 can allow the cover plate 110 to have a certain freedom of movement such that the cover plate 110 can move according to the shape of the groove with trajectory 106. The rack 119 can drive the right end of the connecting rod 140 and the shaft 142 to move in the up-down direction, and the rack 119 can also rotate relative to the connecting rod 140 around the axis of the shaft 142. In addition, the left end of the connecting rod 140 can drive the connecting block 123 of the cover plate 110 to move in the up-down direction, and the connecting rod 140 can also rotate relative to the connecting block 123 around the axis of the shaft 143. In this way, in addition to driving the cover plate 110 to move in the up-down direction, the connecting rod 140 can also drive the cover plate 110 to move in the left-right direction (i.e., in the front-rear direction in FIG. 1C).

In this embodiment, the at least one connecting rod 140 includes two connecting rods 140. The rod portions 141 of the two connecting rods 140 are parallel to each other, and the two connecting rods 140 are disposed side-by-side in the up-down direction. The two connecting rods 140, the rack 119 and the connecting blocks 123 can form a parallel four-connecting-rod structure, so that the cover plate 110 moves more smoothly and does not rotate. In other embodiments, a different number of connecting rods may also be provided. In addition, those skilled in the art should understand that the connecting blocks 123 are provided to facilitate the cover plate 110 to be hinged to the connecting rods 140, and in cover plates of other shapes and structures, there may be no connecting block, or the connecting blocks may be disposed at different positions.

FIGS. 3A and 3B show a structure of the handle assembly 100 when the cover plate 110 is in the closed position. FIG. 3A shows a front view of the handle assembly 100, and FIG. 3B shows a cross-sectional view of the handle assembly 100 shown in FIG. 3A along line A-A, with a partial enlarged view being shown in a dotted circle. As shown in FIGS. 3A and 3B, when the cover plate 110 is in the closed position, the cover plate 110 is located in the housing opening 109 to close the housing opening 109. The limiting pin 122 of the cover plate 110 is located at the leftmost end of the first groove segment 112 of the groove with trajectory 106. At this time, the rack 119 is located at the lowest position, and the two connecting rods 140 are substantially in a horizontal state.

When the gear 118 drives the rack 119 to move upward, the rack 119 first drives the right end of the connecting rod 140 to lift upward, and pulls the cover plate 110 to make it trend to move upward. At this time, the limiting pin 122 of the cover plate 110 slides along the first groove segment 112 so as to limit the cover plate 110 to only obliquely move up to the right, so that the right end of the connecting rod 140 rotates counterclockwise relative to the rack 119 around the axis of the shaft 142, and the left end of the connecting rod 140 rotates counterclockwise relative to the cover plate 110. Until the limiting pin 122 slides to the connection between the first groove segment 112 and the second groove segment 113, the cover plate 110 reaches the retracted position.

FIGS. 4A and 4B show the structure of the handle assembly 100 when the cover plate 110 is in the retracted position. FIG. 4A shows a front view of the handle assembly 100, and FIG. 4B shows a cross-sectional view of the handle assembly 100 shown in FIG. 4A along line B-B, with a partial enlarged view being shown in a dotted circle. As shown in FIGS. 4A and 4B, when the cover plate 110 is in the retracted position, the cover plate 110 is located in the receiving channel 382. The limiting pin 122 of the cover plate 110 is located at the connection between the first groove segment 112 and the second groove segment 113 of the groove with trajectory 106. At this time, the rack 119 has moved upward for a distance, but has not yet reached the uppermost position. The two connecting rods 140 are in an oblique state, and the right end of each connecting rod 140 is located above the left end thereof.

When the gear 118 drives the rack 119 to continue to move upward, the rack 119 continues to drive the right end of the connecting rod 140 to move upward and pulls the cover plate 110 to make it trend to move upward. At this time, the limiting pin 122 of the cover plate 110 slides along the second groove segment 113, so as to limit the cover plate 110 to only vertically move upward. Since the movement direction of the cover plate 110 is consistent with the movement direction of the rack 119, the connecting rods 140 almost no longer rotate relative to the rack 119 and the cover plate 110, but pull the cover plate 110 to move upward. Until the limiting pin 122 slides to the top of the second groove segment 113, the cover plate 110 reaches the open position.

FIGS. 5A and 5B show the structure of the handle assembly 100 when the cover plate 110 is in the open position. FIG. 5A shows a front view of the handle assembly 100, and FIG. 5B shows a cross-sectional view of the handle assembly 100 shown in FIG. 5A along line C-C, with a partial enlarged view being shown in a dotted circle. As shown in FIGS. 5A and 5B, when the cover plate 110 is in the open position, the housing opening 109 is opened, and the cover plate 110 is located in the accommodating cavity 381. The limiting pin 122 of the cover plate 110 is located at the top of the second groove segment 113 of the groove with trajectory 106. The rack 119 reaches the top position and can be covered by the housing 101. The two connecting rods 140 still remain oblique, and the right end of each connecting rod 140 is located above the left end thereof.

When the cover plate 110 is in the open position, the operator's hand can access the operating cavity 138 below the receiving channel 382 through the housing opening 109 to perform desired operations on the operating element in the operating cavity 138, for example, to be detected by the sensing device 133. Since the cover plate 110 is located in the accommodating cavity 381 above the receiving channel 382, the cover plate 110 will not stand in the way of the operator's hand, which is more convenient for the operator to operate.

When the cover plate 110 needs to be closed, the gear 118 drives the rack 119 to move downward, and the cover plate 110 moves from the open position shown in FIGS. 5A and 5B, passes by the retracted position shown in FIGS. 4A and 4B, and then reaches the closed position shown in FIGS. 3A and 3B.

FIGS. 6A and 6B show the structure of the handle assembly 100 when assembled to the door 660. FIG. 6A shows a structure of the handle assembly 100 assembled to the door 660 when the cover plate is in the closed position. FIG. 6B shows a structure of the handle assembly 100 assembled to the door 660 when the cover plate is in the open position. As shown in FIGS. 6A and 6B, the handle assembly 100 is mounted at the rear side or the inner side of the door 660, and the housing opening 109 of the handle assembly 100 is aligned with the handle aperture 661 of the door 660. When the cover plate 110 is in the closed position, the cover plate 110 is located in the housing opening 109 and the handle aperture 661, and the outer surface of the cover plate 110 is flush with an outer surface of the door 660, so that the cover plate 110 can be visually hidden in the handle assembly 100. The seal ring 105 of the handle assembly 100 abuts against an inner surface of the door 660. When the cover plate 110 is in the open position, the handle aperture 661 and the housing opening 109 are both opened such that the operator's hand can access the operating cavity 138 through the handle aperture 661 and the housing opening 109. In addition, when the cover plate 110 is in the open position, the operator can only see the receiving channel 382 and part of the operating cavity 138 from the outside of the door 660, and both the transmission device and the cover plate 110 are covered by the housing, thereby improving the aesthetic appearance of the door 660.

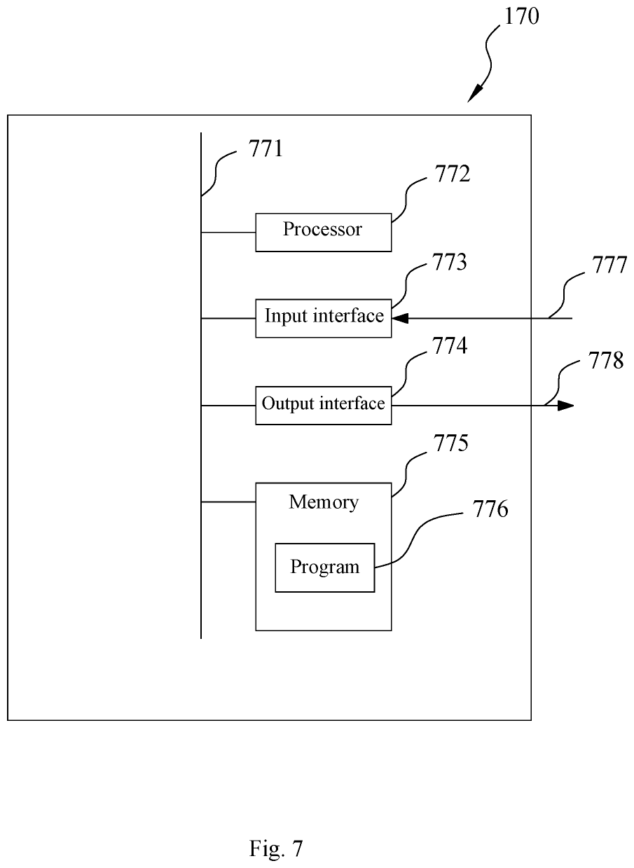

FIG. 7 shows the structure of the controller 170. The controller 170 is configured to control the handle assembly 100. The controller 170 comprises a bus 771, a processor 772, an input interface 773, an output interface 774, and a memory 775 that stores control programs 776. The components in the controller 170, including the processor 772, the input interface 773, the output interface 774 and the memory 775, are communicatively connected to the bus 771, such that the processor 772 can control the operation of the input interface 773, the output interface 774 and the memory 775. Specifically, the memory 775 is configured to store programs, instructions and data, and the processor 772 reads the programs, instructions and data from the memory 775 and can write data to the memory 775. The processor 772 controls the operation of the input interface 773 and the output interface 774 by means of executing the programs and the instructions read from the memory 775.

The input interface 773 is communicatively connected to the sensing device 133 and an operation panel of the vehicle via a connection 777, so as to receive an internal control signal and an external control signal of the sensing device 133 and an instruction from the operation panel in the vehicle and to store the control signals and the instruction to the memory 775. The output interface 774 is communicatively connected to the motor 108 and the door of the vehicle via a connection 778, and by means of executing the program 776 in the memory 775, the controller 170 controls the position of the cover plate 110 of the handle assembly 100 by means of the motor 108, and controls the door of the vehicle to be locked or unlocked.

In some embodiments, the program 776 is configured such that when the cover plate 110 is in the closed position and when the controller 170 receives the external control signal, the cover plate 110 is controlled to move to the open position. In addition, when the cover plate 110 is in the open position and when the controller 170 receives the external control signal or receives no signal for a predetermined time, the cover plate 110 is controlled to move to the closed position.

In addition, in some embodiments, the program 776 is configured such that when the controller 170 receives the internal control signal, the controller 170 controls the door 660 of the vehicle to be unlocked for the operator to open the door 660. When the door 660 is in a closed and unlocked state and when the controller 170 receives the external control signal or receives no signal for a predetermined time, the controller 170 controls the door 660 to be locked.

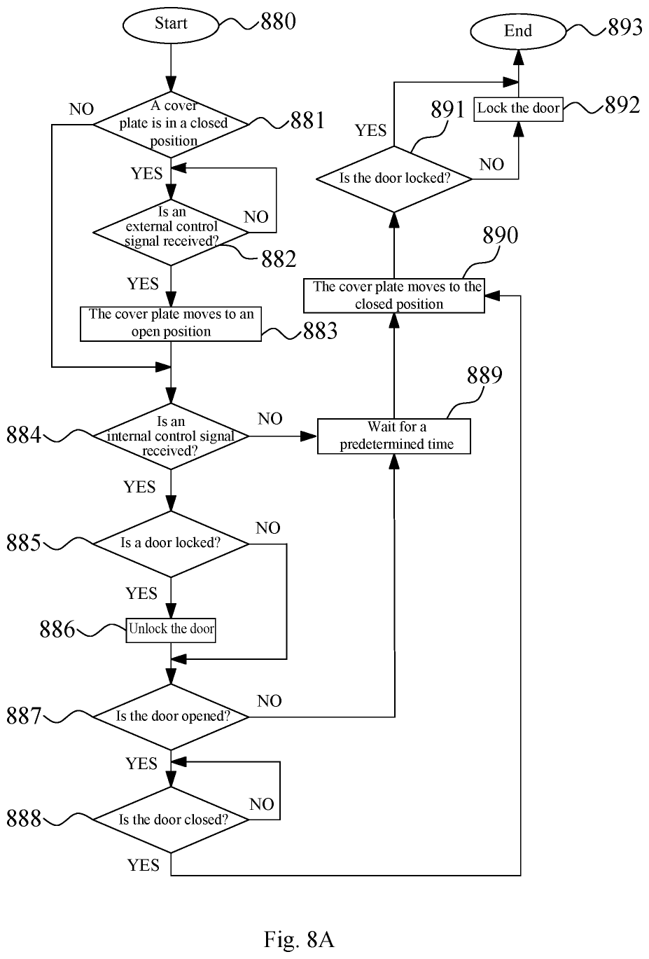

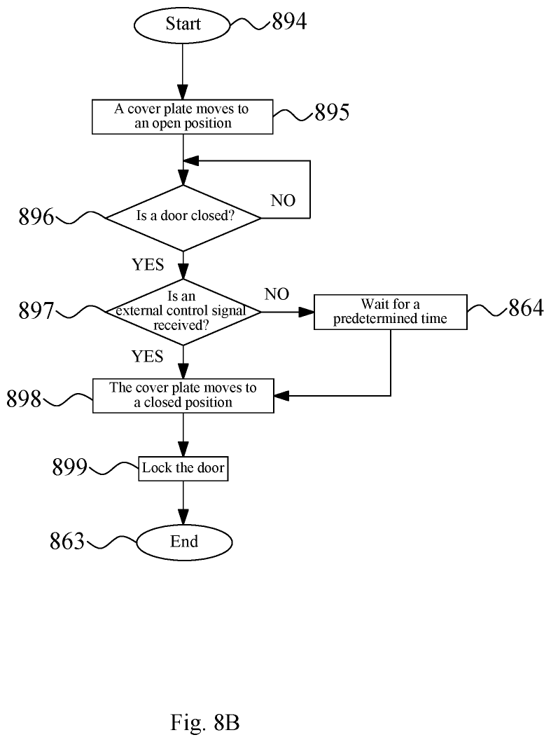

FIGS. 8A and 8B show control program flow charts of some specific embodiments of the handle system. FIG. 8A shows a control program flow chart of a process of a person getting on a vehicle from the outside of the vehicle, and FIG. 8B shows a control program flow chart of a process of the person getting off the vehicle.

As shown in FIG. 8A, when the vehicle detects that a vehicle key is close to a preset position of the vehicle, the controller 170 controls the program to start at step 880 and executes step 881.

At step 881, the controller 170 determines whether the cover plate 110 is in a closed position, and if yes, executes step 882, otherwise executes step 884.

At step 882, the controller 170 determines whether the external control signal is received, and if yes, executes step 883, otherwise returns to step 882.

At step 883, the controller 170 controls the motor 108 to move the cover plate 110 to the open position, so that the operator's hand can access the operating cavity 138 for operation. The controller 170 then executes step 884.

At step 884, the controller 170 determines whether the internal control signal is received, and if yes, executes step 885, otherwise executes step 889.

At step 885, the controller 170 determines whether the door of the vehicle is locked, and if yes, executes step 886, otherwise executes step 887.

At step 886, the controller 170 controls the door of the vehicle to be unlocked such that the operator can open the door of the vehicle and enter the vehicle. The controller 170 then executes step 887.

At step 887, the controller 170 determines whether the door of the vehicle is opened, and if yes, executes step 888, otherwise executes step 889.

At step 888, the controller 170 determines whether the door of the vehicle is closed, and if yes, executes step 890, otherwise executes step 888.

At step 889, the controller 170 waits for a predetermined time and then executes step 890.

At step 890, the controller 170 controls the motor 108 to move the cover plate 110 to the closed position and then executes step 891.

At step 891, the controller 170 continues to determine whether the door is locked, and if yes, executes step 893, otherwise executes step 892.

At step 892, the controller 170 controls the door of the vehicle to be locked and then executes step 893.

At step 893, the program ends.

As shown in FIG. 8B, when the controller 170 receives a corresponding instruction from the operation panel in the vehicle, the controller 170 controls the program to start at step 894 and executes step 895.

At step 895, the controller 170 controls the motor 108 to move the cover plate 110 to the open position and then executes step 896.

At step 896, the controller 170 determines whether the door of the vehicle is closed, and if yes, executes step 897, otherwise executes step 896.

At step 897, the controller 170 determines whether the external control signal is received, and if yes, executes step 898, otherwise executes step 864.

At step 864, the controller 170 waits for a predetermined time and then executes step 898.

At step 898, the controller 170 controls the motor 108 to move the cover plate 110 to the closed position and then executes step 899.

At step 899, the controller 170 controls the door of the vehicle to be locked and then executes step 863.

At step 863, the program ends.

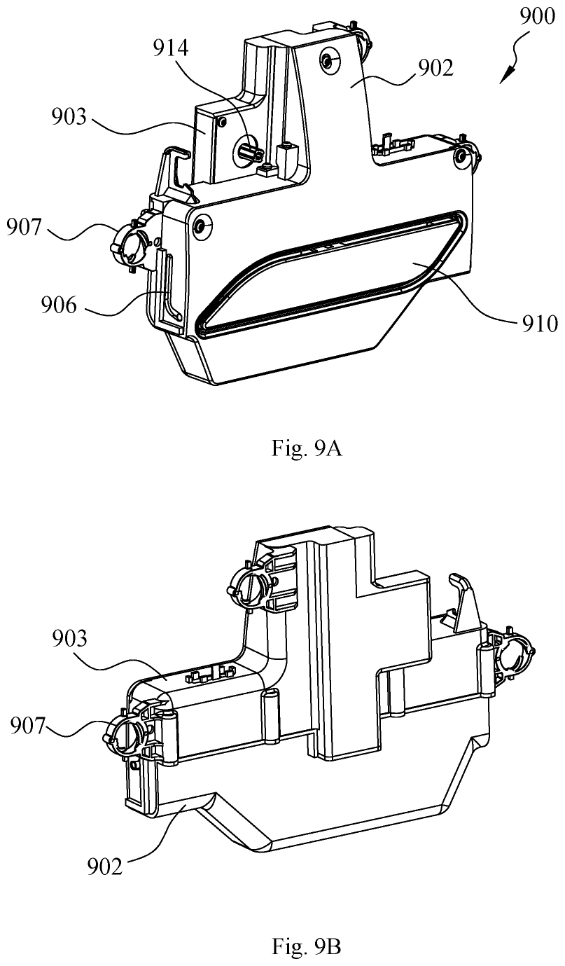

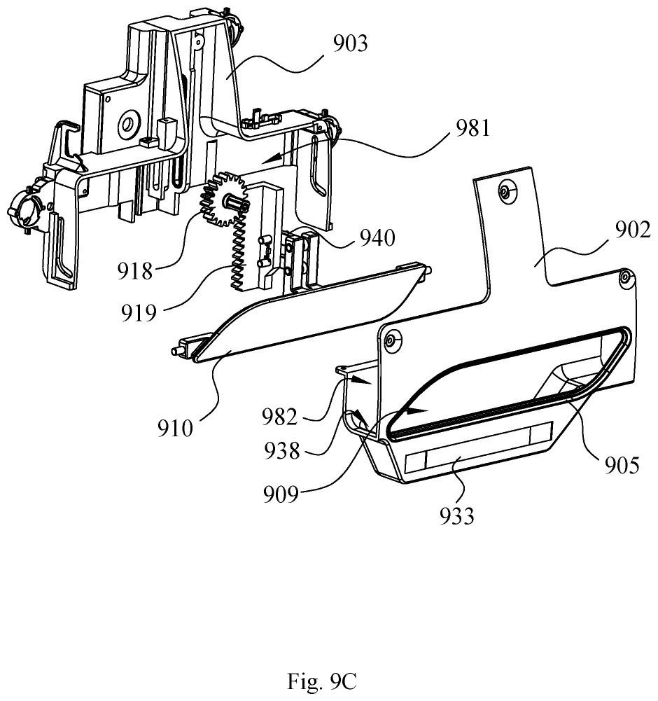

FIGS. 9A to 9C show the specific structure of a handle assembly 900 according to another embodiment of the present disclosure. FIG. 9A shows a structural perspective diagram of the handle assembly 900 from a front-to-rear perspective, FIG. 9B shows a structural perspective diagram of the handle assembly 900 from a rear-to-front perspective, and FIG. 9C shows an exploded view of the handle assembly 900. The sensing device 933 is not shown in FIG. 9A. As shown in FIGS. 9A to 9C, the handle assembly 900 has substantially the same structure as the handle assembly 100, and the difference lies in that, instead of consisting of a box and a front end plate that closes the open front portion of the box, the housing 901 of the handle assembly 900 comprises an upper housing 903 and a lower housing 902 that are detachably connected to each other, the upper housing 903 forms a top wall, side walls and a part of a rear side wall of the handle assembly 900, and the lower housing 902 forms a bottom wall, a front side wall and the other part of the rear side wall of the handle assembly 900. The upper housing 903 is connected to the lower housing 902 by means of a fastening structure, for example, by means of a bolt. The groove with trajectories 906 are formed on a pair of side walls of the upper housing 903, the housing opening 909 is formed on the front side wall of the lower housing 902, and the sensing device 933 is disposed on the front side wall of the lower housing 902. In this embodiment, the operating cavity 938 is defined by the lower housing 902. In addition, the side wall of the upper housing 903 and the rear side wall of the lower housing 902 jointly define the receiving channel 982. The front side wall of the upper housing 903 and the front side wall of the lower housing 902 jointly define the accommodating cavity 981. In this embodiment, the structure and movement process of the cover plate 910 are consistent with the structure and movement process of the cover plate 110 in the handle assembly 100, which will not be described again herein.

In the embodiment as shown in FIGS. 9A to 9C, the transmission device also comprises a gear 918, a rack 919 and at least one connecting rod 940. The gear 918 is meshed with the rack 919 and drives the rack 919 to move in the up-down direction. The connecting rod 940 is respectively hinged to the rack 919 and the cover plate 910. In this embodiment, the gear 918 is disposed at the left side of the rack 919. The gear 918 axially extends in the front-rear direction, and a power receiving portion 914 of the gear 918 extends in the front-rear direction and extends out of the upper housing 903 to be engaged with the motor (the motor is not shown in the figures). In addition, the rack 919 is of a L shape extending in the up-down direction, a portion thereof extending in the left-right direction is provided with teeth meshed with the gear 918, and a portion thereof extending in the front-rear direction is configured to be hinged to the connecting rod 940. In this embodiment, the gear 918 is disposed at the left side of the rack 919, instead of at the rear side of the rack 919, so that for the handle assembly 100, the thickness of the handle assembly 900 in the front-rear direction can be further reduced.

Furthermore, in this embodiment, the handle assembly 900 further comprises at least one positioning member 907. The positioning member 907 is configured to be connected to a positioning structure (not shown in the figures) on the door, so as to position and connect the handle assembly 900 to the rear side of the door. In other embodiments, the handle assembly may also be connected to the door in other ways.

In the handle assembly of the present disclosure, when the cover plate is in the open position, the cover plate and the operating element are respectively located in the accommodating cavity and the operating cavity, so that the cover plate will not hinder the operator's hand from operating the operating element, so as to prevent the operator's hand from hitting the cover plate. In addition, when the cover plate is in the open position, the housing can also cover the transmission device at the rear side, making the door have a more artistic appearance.

In the handle system of the present disclosure, the cover plate is driven by the motor to move, so that the handle assembly can be electrically connected to the controller, and thus the cover plate can be automatically opened or closed by means of the controller. Furthermore, the motor-driven handle assembly of the present disclosure also eliminates the possible interference from external factors when the cover plate is driven by a mechanical device to move, for example, eliminates the possibility of the operator's hand being jammed due to the cover plate resetting to the closed position too quickly.

In addition, the transmission device of the present disclosure performs transmission by means of the gear, the rack and the connecting rod, which form a simple structure, and limits the movement trajectory of the cover plate by means of the limiting pin and the groove with trajectory, so that the cover plate moves in the front-rear direction only when the limiting pin is in the first groove segment. In this way, the cover plate has a small movement distance in the front-rear direction, saving on the space occupied by the handle assembly in the front-rear direction. In addition, the cover plate only performs translational movements and does not rotate, and thus requires smaller movement space than a rotating cover plate, when the cover plates have the same size. In this way, according to the handle assembly of the present disclosure, the handle assembly can have a smaller thickness.

Furthermore, the handle assembly of the present disclosure further comprises an ultrasonic sensor as the sensing device. There is no need for the operator to directly touch the ultrasonic sensor, so that the detection result of the ultrasonic sensor will not be affected even if the operator's hand is wet. In addition, since the ultrasonic sensor has the characteristics of penetrating metal and plastic materials, the handle assembly of the present disclosure has no requirement on the material and thickness of the handle assembly and the vehicle door and also has no requirement on the spray paint, even the surface of a door made of metal and a paint-coated door with a high conductivity will not affect the signal collection of the ultrasonic sensor, and there will be no false triggering when a metal object approaches. In addition, the signal collection and calculation of the ultrasonic sensor are completed by a chip integrated with the sensor, without the need for an additional processing chip.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents. The technical effects and technical problems in this specification are exemplary rather than limiting. It should be noted that the embodiments described in this specification may have other technical effects and can solve other technical problems.

1. A handle assembly for a door (660) having a handle aperture (661), the handle assembly comprising:
a housing (101) defining an accommodating cavity (381), a receiving channel (382) and an operating cavity (138) and having a housing opening (109), wherein the receiving channel (382) is located at a rear side of the housing opening (109), the accommodating cavity (381) and the operating cavity (138) are respectively located at the opposite upper side and lower side of the receiving channel (382) and interconnected to each other through the receiving channel (382), and the housing opening (109) is configured to be aligned with the handle aperture (661) of the door (660);
a cover plate (110) having a closed position and an open position, and the cover plate (110) being configured to close the handle aperture (661) of the door (660) in the closed position and to open the handle aperture (661) of the door (660) in the open position; and
a transmission device (118, 119, 140) disposed in the housing (101) and connected to the cover plate (110), and the transmission device (118, 119, 140) being capable of moving the cover plate (110) between the closed position and the open position in response to an electronic signal;
wherein the accommodating cavity (381) of the housing (101) is configured to accommodate the cover plate (110) when the cover plate (110) is in the open position, and the operating cavity (138) of the housing (101) is configured to at least partially accommodate an operator's hand for opening the door (660).

2. The handle assembly according to claim 1, wherein
the cover plate (110) also has a retracted position, and the cover plate (110) is arranged such that the cover plate (110) is located in the receiving channel (382) when the cover plate (110) is in the retracted position; and
the transmission device (118, 119, 140) is configured to move the cover plate (110) back and forth between the closed position and the retracted position, and to move the cover plate (110) up and down between the retracted position and the open position.

3. The handle assembly according to claim 2, wherein
a back-and-forth movement of the cover plate (110) between the closed position and the retracted position and an up-and-down movement between the retracted position and the open position are translational movements.

4. The handle assembly according to claim 3, wherein
the transmission device (118, 119, 140) comprises a gear (118), a rack (119) and at least one connecting rod (140), the gear (118) and the rack (119) that are meshed with each other, the at least one connecting rod (140) is hinged to the rack (119) and the cover plate (110) respectively to connect the rack (119) and the cover plate (110), and the rack (119) extends in an up-down direction;
the handle assembly further comprises a limiting structure disposed on the cover plate (110) and a fitting structure for the limiting structure disposed on the housing (101), and the limiting structure is engaged with the fitting structure for the limiting structure;
wherein the transmission device (118, 119, 140), the limiting structure and the fitting structure for the limiting structure enable the cover plate (110) to move back and forth between the closed position and the retracted position, and to move up and down between the retracted position and the open position.

5. The handle assembly according to claim 4, wherein
the limiting structure comprises a limiting pin (122) disposed on at least one end of the cover plate (110) in a left-right direction of the cover plate (110), the fitting structure for the limiting structure comprises a groove with trajectory (106) formed on an inner wall of the housing (101), and the limiting pin (122) is capable of sliding in the groove with trajectory (106).

6. The handle assembly according to claim 5, wherein
the groove with trajectory (106) comprises a first groove segment (112) and a second groove segment (113) interconnected to each other, the second groove segment (113) extends parallel to the rack (119), and the first groove segment (112) is located below the second groove segment (113) and extends obliquely relative to the second groove segment (113);
wherein the cover plate (110) is configured such that the cover plate (110) moves between the closed position and the retracted position when the limiting pin (122) is sliding in the first groove segment (112), and the cover plate (110) moves between the retracted position and the open position when the limiting pin (122) is sliding in the second groove segment (113).

7. The handle assembly according to claim 1, wherein
the handle assembly (100) further comprises an operating element, the operating element comprises a sensing device (133) configured to detect the operator's hand and to send a signal.

8. The handle assembly according to claim 7, wherein
the sensing device (133) is disposed on a side wall of the housing (101) close to the handle aperture (661) to allow the operator's hand to access the operating cavity (138) from the housing opening (109) through the receiving channel (382) so as to be detected by the sensing device (133).

9. The handle assembly according to claim 7, wherein
the sensing device (133) comprises a capacitive sensor.

10. The handle assembly according to claim 7, wherein
the sensing device (133) comprises an ultrasonic sensor (135, 136).

11. The handle assembly according to claim 7, wherein
a pair of side walls (132) of the housing (101) defining the operating cavity (138) extend obliquely relative to each other from top to bottom, so that the operating cavity (138) has a bottom dimension smaller than its top dimension.

12. The handle assembly according to claim 1, wherein
the handle assembly (100) further comprises a seal ring (105) surrounding the housing opening (109) and the cover plate (110) for connecting between the housing (101) and the door (660).

13. The handle assembly according to claim 1, further comprising:
a motor (108) connected to the transmission device (118, 119, 140) and configured to provide a driving force to the transmission device (118, 119, 140) in response to the electronic signal.

14. The handle assembly according to claim 1, wherein
the handle assembly (100) is configured such that the cover plate (110) is substantially flush with an outer surface of the door (660) when the cover plate (110) is in the closed position.

15. A handle system for a door (660) having a handle aperture (661), the handle system comprising:
a handle assembly (100) comprising:
a housing (101) defining an accommodating cavity (381), a receiving channel (382) and an operating cavity (138), wherein the receiving channel (382) is located at a rear side of the handle aperture (661) of the door (660), the accommodating cavity (381) and the operating cavity (138) are respectively located at the opposite upper side and lower side, of the receiving channel (382) and interconnected to each other through the receiving channel (382);
a cover plate (110) having a closed position and an open position, the accommodating cavity (381) of the housing (101) is configured to accommodate the cover plate (110) when the cover plate (110) is located in the open position, and the operating cavity (138) of the housing (101) is configured to at least partially accommodate an operator's hand for opening the door (660); and
an operating element comprising a sensing device (133) configured to detect the operator's hand and to send a control signal; and
a controller (170) receiving the control signal from the sensing device (133) to control the cover plate (110) to move from the closed position to the open position, or to control the cover plate (110) to move from the open position to the closed position.

16. The handle system according to claim 15, wherein
the controller (170) controls the door (660) to be locked or unlocked according to the control signal.

17. The handle system according to claim 16, wherein
the control signal comprises an external control signal or an internal control signal; and
the sensing device (133) comprises a capacitive sensor, wherein the capacitive sensor is configured to:
send the external control signal in response to a contact by the operator's hand outside the handle assembly (100); or
send the internal control signal in response to a contact by the operator's hand inside the operating cavity (138) of the handle assembly (100).

18. The handle system according to claim 16, wherein
the control signal comprises an external control signal and an internal control signal; and
the sensing device (133) comprises an ultrasonic sensor, wherein the ultrasonic sensor is configured to:
send the external control signal in response to the operator's hand within a predetermined distance outside the handle assembly (100); or
send the internal control signal in response to the operator's hand inside the operating cavity (138) of the handle assembly (100).

19. The handle system according to claim 17, wherein
when the cover plate (110) is in the closed position and when the controller (170) receives the external control signal, the controller (170) controls the cover plate (110) to move to the open position; and
when the cover plate (110) is in the open position and when the controller (170) receives the external control signal or the controller (170) receives no signal for a predetermined time, the controller (170) controls the cover plate (110) to move to the closed position.

20. The handle system according to claim 17, wherein
when the controller (170) receives the internal control signal, the controller (170) controls the door (660) to be unlocked for an operator to open the door (660); and
when the door (660) is in a closed and unlocked state and when the controller (170) receives the external control signal or receives no signal for a predetermined time, the controller (170) controls the door (660) to be locked.
